(19) United States
(12) Patent Application Publication
(10) Pub. No.: US 2022/0129736 A1
(43) Pub. Date: Apr. 28, 2022

(54) MIXED-PRECISION QUANTIZATION METHOD FOR NEURAL NETWORK

(71) Applicant: Cvitek Co. Ltd., Beijing (CN)

(72) Inventors: Bau-Cheng SHEN, New Taipei City (TW); Hsi-Kang TSAO, Hsinchu City (TW); Chun-Yu LAI, New Taipei City (TW)

(21) Appl. No.: 17/483,567

(22) Filed: Sep. 23, 2021

(30) Foreign Application Priority Data
Oct. 27, 2020 (CN) 202011163813.4

(51) Int. Cl. G06N 3/04; G06F 17/18

(52) U.S. Cl. CPC G06N 3/0472; G06F 17/18

(57) ABSTRACT

A mixed-precision quantization method for a neural network is provided. The neural network has a first precision and includes several layers and an original final output. For a particular layer, quantization of second precision on the particular layer and an input is performed. An output of the particular layer is obtained according to the particular layer of second precision and the input. De-quantization on the output of the particular layer is performed, and the de-quantized output is inputted to a next layer to obtain a final output. A value of an objective function is obtained according to the final output and the original final output. Above steps are repeated until the value of the objective function of each layer is obtained. A precision of quantization for each layer is decided according to the value of the objective function. The precision of quantization is one of first to fourth precision.

This application claims the benefit of People's Republic of China application Serial No. 202011163813.4, filed Oct. 27, 2020, the subject matter of which is incorporated herein by reference.

### BACKGROUND OF THE INVENTION

### Field of the Invention

The invention relates in general to a mixed-precision quantization method, and more particularly to a mixed-precision quantization method for a neural network.

### Description of the Related Art

In the application of the neural network, prediction process requires a large amount of computing resources. Although neural network quantization can reduce the computing cost, quantization may affect prediction precision at the same time. The currently available quantization methods quantize the entire neural network with the same precision. However, these methods lack flexibility. Furthermore, most of the currently available quantization methods require a large amount of labeled data and the labeled data need to be integrated to the training process.

Also, when determining the quantization loss of a specific layer of the neural network, the currently available quantization methods only consider the state of the specific layer, such as the output loss or weighted loss of the specific layer and neglect the impact on the final result caused by the specific layer. The currently available quantization methods cannot achieve balance between cost and prediction precision. Therefore, it has become a prominent task for the industries to provide a quantization method to resolve the above problems.

### SUMMARY OF THE INVENTION

The invention proposed a mixed-precision quantization method for a neural network capable of deciding the precision for each layer according to the loss of the original final output with respect to the final output of quantized neural network.

According to one embodiment of the present invention, a mixed-precision quantization method for a neural network is provided. The neural network has a first precision and includes a plurality of layers and an original final output. The mixed-precision quantization method includes the following steps. For a particular layer of the plurality of layer, quantization of a second precision on the particular layer and an input of the particular layer is performed. An output of the particular layer is obtained according to the particular layer with the second precision and the input of the particular layer. De-quantization on the output of the particular layer is performed and the de-quantized output of the particular layer is inputted to a next layer. A final output is obtained. A value of an objective function is obtained according to the final output and the original final output. The above steps are repeated until the value of the objective function corresponding to each layer is obtained. A precision of quantization for each layer is decided according to the value of the objective function corresponding to each layer. The precision of the quantization is the first precision, the second precision, a third precision, or a fourth precision.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a schematic diagram of a neural network according to an embodiment of the present invention.

FIG. 2 is a schematic diagram of a mixed-precision quantization device of a neural network according to an embodiment of the present invention.

FIG. 3 is a flowchart of a mixed-precision quantization method for a neural network according to an embodiment of the present invention.

FIG. 4 is a schematic diagram of performing quantization on the first layer of the neural network and the input of the first layer according to an embodiment of the present invention.

FIG. 5 is a schematic diagram of performing quantization on the second layer of the neural network and the input of the second layer according to an embodiment of the present invention.

FIG. 6 is a schematic diagram of performing quantization on the third layer of the neural network and the input of the third layer according to an embodiment of the present invention.

FIG. 7 is a flowchart of a mixed-precision quantization method for a neural network according to another embodiment of the present invention.

### DETAILED DESCRIPTION OF THE INVENTION

Although the present disclosure does not illustrate all possible embodiments, other embodiments not disclosed in the present disclosure are still applicable. Moreover, the dimension scales used in the accompanying drawings are not based on actual proportion of the product. Therefore, the specification and drawings are for explaining and describing the embodiment only, not for limiting the scope of protection of the present disclosure. Furthermore, descriptions of the embodiments, such as detailed structures, manufacturing procedures and materials, are for exemplification purpose only, not for limiting the scope of protection of the present disclosure. Suitable changes or modifications can be made to the procedures and structures of the embodiments to meet actual needs without breaching the spirit of the present disclosure.

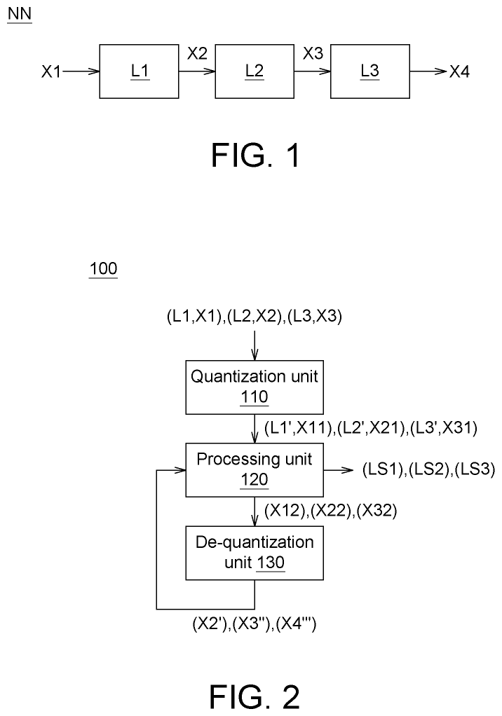

Referring to FIG. 1, a schematic diagram of a neural network according to an embodiment of the present invention is shown. The neural network has a first layer L1, a second layer L2 and a third layer L3. The first layer L1 has an input X1 and an output X2. The second layer L2 has an input X2 and an output X3. The third layer L3 has an input X3 and an output X4. That is, X2 is the output of the first layer L1 and also the input of the second layer L2; X3 is the output of the second layer L2 and also the input of the third layer L3; X4 is the final output of the neural network and is referred as the original final output hereinafter. The neural network is a trained neural network and computes with a first precision. The first precision is such as 32-bit floating point (FP32) or 64-bit floating point (FP64), and the present invention is not limited thereto. In another embodiment, the neural network can have two or more layers. For the convenience of description, the neural network exemplarily has three layers.

Referring to FIG. 2, a schematic diagram of a mixed-precision quantization device 100 of a neural network according to an embodiment of the present invention is shown. The mixed-precision quantization device 100 includes a quantization unit 110, a processing unit 120 and a de-quantization unit 130. The quantization unit 110, the processing unit 120 and the de-quantization unit 130 can be implemented by a chip, a circuit board, or a circuit.

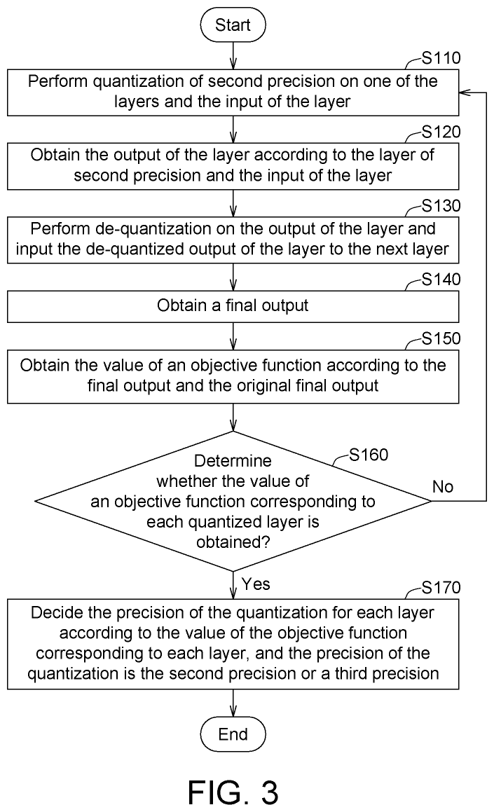

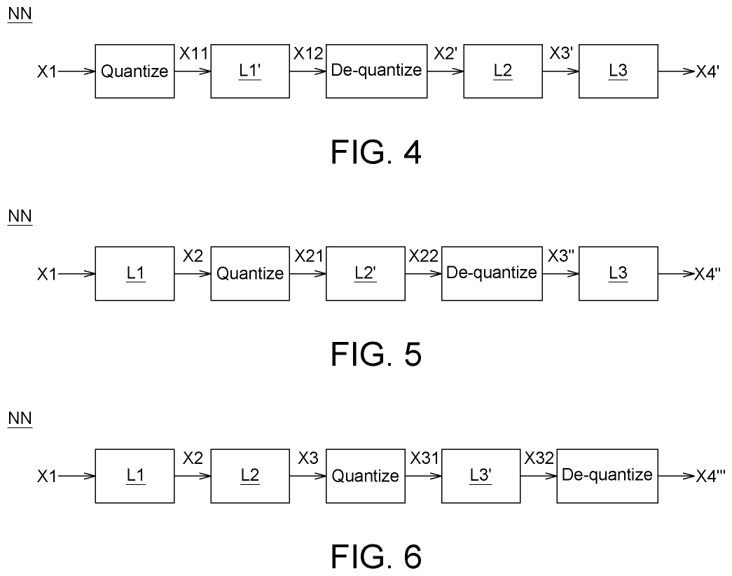

FIG. 3 is a flowchart of a mixed-precision quantization method for a neural network according to an embodiment of the present invention. FIG. 4 is a schematic diagram of performing quantization on the first layer of the neural network and the input of the first layer L1 according to an embodiment of the present invention. FIG. 5 is a schematic diagram of performing quantization on the second layer L2 of the neural network and the input of the second layer according to an embodiment of the present invention. FIG. 6 is a schematic diagram of performing quantization on the third layer L3 of the neural network and the input of the third layer according to an embodiment of the present invention. In the disclosure below, it is exemplified that hardware supports two types of quantization precision, namely the second precision and the third precision. The second precision and the third precision respectively are one of 4-bit integer (INT4), 8-bit integer (INT8), and 16-bit brain floating point (BF16), but the present invention is not limited thereto. In the present embodiment, the first precision is higher than the second precision and the third precision, and the third precision is higher than the second precision. Refer to FIG. 1 to FIG. 6.

In step S110, quantization of second precision is performed on one of the layers of the neural network and the input of the layer by the quantization unit 110. For example, the quantization unit 110 firstly performs the quantization of second precision on the first layer L1 and the input X1 of the first layer L1 to obtain a first layer L1′ and an input X11 both having the second precision as indicated in FIG. 2 and FIG. 4.

In step S120, the output of the layer is obtained by the processing unit 120 according to the layer of second precision and the input of the layer. For example, the processing unit 120 obtains an output X12 according to the first layer L1′ and the input X11 of the first layer L1′ which have been quantized to have the second precision as indicated in FIG. 2 and FIG. 4. The output X12 has the second precision.

In step S130, de-quantization is performed on the output of the layer, and the de-quantized output of the layer is inputted to the next layer. For example, the de-quantization unit 130 performs de-quantization on the output X12 of the first layer L1′ to obtain the output X2′ of the first layer L1′ which has been de-quantized and the de-quantization unit 130 input the output X2′ to the second layer L2 as indicated in FIG. 4. The de-quantized output X2′ has the first precision.

In step S140, a final output is obtained by the processing unit 120. For example, the processing unit 120 obtains an output X3′ of the second layer L2 and the processing unit 120 inputs an output X3′ to the third layer L3 as indicated in FIG. 4. Then, an output X4′ of the third layer L3 is obtained. The output X4′ is the final output of the neural network. The second layer L2, the output X3′ of the second layer L2, the third layer L3, and the output X4′ of the third layer L3 have the first precision. That is, in FIG. 4, only the input X11 of the first layer L1′, the first layer L1′, and the output X12 of the first layer L1′ have the second precision.

In step S150, the value of an objective function is obtained by the processing unit 120 according to the final output and the original final output. For example, the processing unit 120 obtains the value of the objective function LS1 according to the final output X4′ and the original final output X4. The objective function LS1 can be signal-to-quantization-noise ratio (SQNR), cross entropy, cosine similarity, or KL divergence (Kullback-Leibler divergence). However, the present invention is not limited thereto, and any functions capable of calculating the loss between the final output X4′ and the original final output X4 can be applied as the objective function LS1. In another embodiment, the processing unit 120 obtains the value of the objective function LS1 according to part of the final output X4′ and part of the original final output X4. For example, the neural network is used in object detection, therefore the final output X4′ and the original final output X4 include coordinates and categories, and the processing unit 120 can obtain the value of the objective function LS1 according to the coordinates of the final output X4′ and the coordinates of the original final output X4.

In another embodiment, when a number of final outputs X4′ and a number of original final outputs X4 are obtained, in step S150, the processing unit 120 can obtain the value of the objective function according to the final outputs X4′ and the original final outputs X4. For example, the processing unit 120 can use the average or weighted average of the final outputs X4′ and the original final outputs X4 or part of the final outputs X4′ and part of the original final outputs X4 to obtain the value of the objective function. However, the present invention is not limited thereto, and any method can be applied to obtain the value of the objective function as long as the value of the objective function can be obtained according to the final outputs X4′ and the original final outputs X4.

In step S160, whether the value of the objective function corresponding to each quantized layer is obtained is determined by the processing unit 120. If yes, the method proceeds to step S170; otherwise, the method returns to step S110. In step S110, the quantization of second precision is performed on another layer (for example, the second layer L2 or the third layer L3) and the input of the another layer (the input X2 of the second layer L2 or the input X3 of the third layer L3) by the quantization unit 110 to obtain the value of the objective function corresponding to the another layer. That is, steps S110 to S150 will be performed several times until the value of the objective function corresponding to each layer is obtained, and each time of performing steps S110 to S150 is independent of each other. For example, after the value of the objective function LS1 corresponding to the quantized final output X4′ of the first layer L1 and the original final output X4 (as shown in FIG. 1, FIG. 2 and FIG. 4) is obtained, steps S110 to S150 are performed again to obtain the value of the objective function LS2 corresponding to the quantized final output X4″ of the second layer L2 and the original final output X4 (as shown in FIG. 1, FIG. 2 and FIG. 5), and steps S110 to S150 are performed again to obtain the value of the objective function LS3 corresponding to the quantized final output X4′″ of the third layer L3 and the original final output X4 (as shown in FIG. 1, FIG. 2 and FIG. 6). After the value of the objective function corresponding to each layer is obtained, the method proceeds to step S170.

In step S170, the precision of the quantization for each layer is decided by the processing unit 120 according to the value of the objective function corresponding to each layer. Furthermore, the processing unit 120 determines that each layer is quantized with the second precision or the third precision according to whether the value of the objective function corresponding to each layer is greater than a threshold. For example, when the value of the objective function corresponding to the first layer L1 is greater than the threshold, this indicates that the loss is small, and the processing unit 120 decides to quantize the first layer L1 with the second precision. When the value of the objective function corresponding to the second layer L2 is not greater than the threshold, this indicates that the loss is large, and the processing unit 120 decides to quantize the second layer L2 with the third precision. When the value of the objective function corresponding to the third layer L3 is not greater than the threshold, this indicates that the loss is large, and the processing unit 120 decides to quantize the third layer L3 with the third precision. In other words, the layer with a larger quantization loss is quantized with the third precision which has higher precision of quantization among the two types of quantization precision that hardware can support. The layer with a smaller quantization loss is quantized with the second precision which has the lower precision of quantization among the two types of quantization precision that hardware can support.

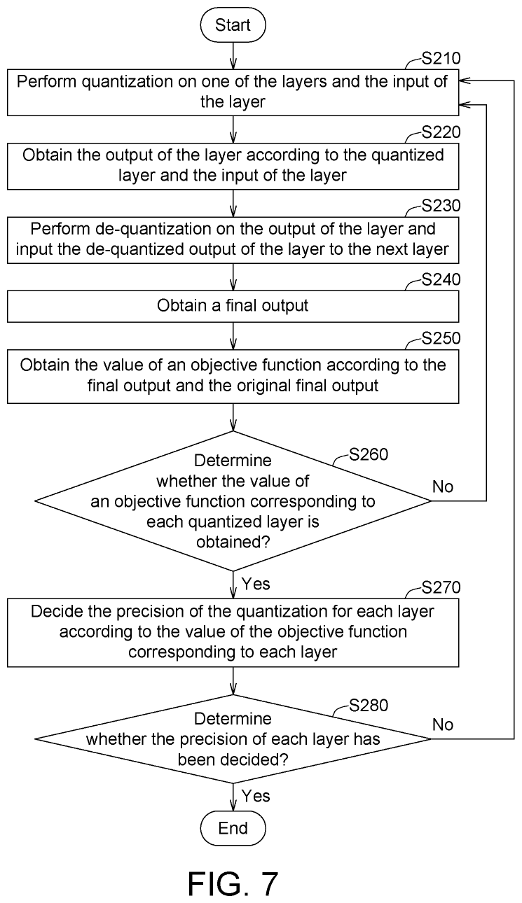

FIG. 7 is a flowchart of a mixed-precision quantization method for a neural network according to another embodiment of the present invention. The mixed-precision quantization method is described with the schematic diagram of the neural network of FIG. 1 and the flowchart of FIG. 7. The neural network is a trained neural network and performs computation with a first precision. The first precision is such as 32-bit floating point (FP32) or 64-bit floating point (FP64), and the present invention is not limited thereto. In the description below, it is exemplified that hardware supports four types of quantization precision, namely the first precision, the second precision, the third precision and the fourth precision. The second precision, the third precision and the fourth precision respectively are one of 4-bit integer (INT4), 8-bit integer (INT8), and 16-bit brain floating point (BF16), but the present invention is not limited thereto. In the present embodiment, the first precision is higher than the second precision, the third precision and the fourth precision, the fourth precision is higher than the third precision, and the third precision is higher than the second precision. Refer to FIG. 1, FIG. 2, and FIG. 4 to FIG. 7. Steps S210 to S260 of FIG. 7 are similar to steps S110 to S160 of FIG. 3, and the similarities are not repeated here. In FIG. 7, steps S210 to S260 are performed with the second precision for several times to obtain the value of the objective function corresponding to each layer quantized with the second precision. Then, the method proceeds to step S270.

In step S270, the precision of the quantization for each layer is decided by the processing unit 120 according to the value of the objective function corresponding to each layer. Furthermore, the processing unit 120 determines that each layer is quantized with the second precision, or further determines that each layer is quantized with the third precision or the fourth precision, according to whether the value of the objective function corresponding to each layer is greater than a threshold. For example, when the value of the objective function corresponding to the first layer L1 is greater than the threshold, this indicates that the loss is small, and the processing unit 120 decides to quantize the first layer L1 with the second precision. when the values of the objective function corresponding to the second layer L2 and the third layer L3 is not greater than the threshold, this indicates that the loss is large, and the processing unit 120 may decide to quantize the second layer L2 and the third layer L3 with the third precision or the fourth precision or does not quantize the second layer L2 and the third layer L3 (that is, the second layer L2 and the third layer L3 remain at the first precision).

Then, the method proceeds to step S280, whether the precision of each layer has been decided is determined by the processing unit 120. If yes, the method terminates; otherwise, the method returns to step S210, and steps S210 to S260 are performed for several times with another precision (for example, the third precision) until the value of the objective function corresponding to each quantized layer (the second layer L2 and the third layer L3), whose precision has not been decided, is obtained. Then, the method proceeds to step S270, the precision of the quantization for each layer, whose precision has not been decided, is decided by the processing unit 120 according to the value of the objective function corresponding to each layer (the second layer L2 and the third layer L3), whose precision has not been decided. The embodiment of FIG. 7 is different from the embodiment of FIG. 3 in that the chosen precision of quantization for the layers in the method of FIG. 7 can has more than two types of quantization precision. After steps S210 to S270 are performed with the second precision, the processing unit 120 only determines that the precision of the quantization of the first layer L1 is second precision, but the precision of the quantization of the second layer L2 and the third layer L3 has not been decided. For example, the precision of the quantization for the second layer L2 and the third layer L3 may be the third precision or the fourth precision, or it is decided that the second layer L2 and the third layer L3 would not be quantized (that is, the second layer L2 and the third layer L3 remain at the first precision). Therefore, steps S210 to S270 are performed again for the second layer L2 and the third layer L3, whose precision has not been decided, with the third precision so as to decide the precision of the quantization for the second layer L2 and the third layer L3. For example, in step S280, since the processing unit 120 decides that the precision of the quantization for the second layer L2 and the third layer L3 have not been decided, the method returns to step S210. Then, steps S210 to S260 are performed with the third precision, and the value of the objective function corresponding to the second layer L2 and the value of the objective function corresponding to the third layer L3 are obtained. Then, the method proceeds to step S270, the precision of the quantization for the second layer L2 and the precision of the quantization for the third layer L3 are decided by the processing unit 120 according to the value of the objective function corresponding to the second layer L2 and the value of the objective function corresponding to the third layer L3. Furthermore, the processing unit 120 decides to quantize the second layer L2 and the third layer L3 respectively with the third precision or the fourth precision according to whether the value of the objective function corresponding to the second layer L2 and the value of the objective function corresponding to the third layer L3 are greater than another threshold. For example, when the value of the objective function corresponding to the second layer L2 is greater than the another threshold, this indicates that the loss is small, and the processing unit 120 decides to quantize the second layer L2 with the third precision. when the value of the objective function corresponding to the third layer L3 is not greater than the another threshold, this indicates that the loss is large, and the processing unit 120 decides to quantize the third layer L3 with the fourth precision or the processing unit 120 decides not to quantize the third layer L3 (that is, the third layer L3 remains at the first precision).

In step S280, since the processing unit 120 determines that the precision of the quantization for the third layer L3 has not been decided, the method returns to step S210. Then, steps S210 to S260 are performed with the fourth precision, and the value of the objective function corresponding to the third layer L3 is obtained. Then, the method proceeds to step S270, the precision of the quantization for the third layer L3 is decided by the processing unit 120 according to the value of the objective function corresponding to the third layer L3. Furthermore, the processing unit 120 decides to quantize the third layer L3 with the fourth precision or decides not to quantize the third layer L3 (that is, the third layer L3 remains at the first precision) according to whether the value of the objective function corresponding to the third layer L3 is greater than another threshold. For example, when the value of the objective function corresponding to the third layer L3 is greater than the another threshold, this indicates that the loss is small, and the processing unit 120 decides to quantize the third layer L3 with the fourth precision. When the value of the objective function corresponding to the third layer L3 is not greater than the another threshold, this indicates that the loss is large, and the processing unit 120 decides not to quantize the third layer L3 (that is, the third layer L3 remains at the first precision).

The mixed-precision quantization methods for a neural network of FIG. 3 and FIG. 7 are performed in the unit of layer. However, in another embodiment, the present invention can be performed in the unit of tensor, and the present invention is not limited thereto. In other words, the mixed-precision quantization method for a neural network of the present invention can decide the precision of the quantization for a particular part according to the loss of the final output of the neural network corresponding to the quantized particular part.

Through the mixed-precision quantization method for a neural network of the present invention, the precision of the quantization for each part can be decided according to the loss of the final output of the neural network corresponding to each quantized part. Therefore, the prevent invention can achieve best balance between cost and prediction precision. Furthermore, the mixed-precision quantization method for a neural network of the present invention can be implemented by using a small amount of unmarked data (for example, 100 to 1000 items) without having to be integrated in the training process of the neural network.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mixed-precision quantization method for a neural network, wherein the neural network has a first precision and comprises a plurality of layers and an original final output, and the mixed-precision quantization method comprises:
for a particular layer of the plurality of layer, performing quantization of a second precision on the particular layer and an input of the particular layer;
obtaining an output of the particular layer according to the particular layer with the second precision and the input of the particular layer;
performing de-quantization on the output of the particular layer and inputting the de-quantized output of the particular layer to a next layer;
obtaining a final output;
obtaining a value of an objective function according to the final output and the original final output;
repeating the above steps until the value of the objective function corresponding to each layer is obtained; and
deciding a precision of quantization for each layer according to the value of the objective function corresponding to each layer;
wherein the precision of the quantization is the first precision, the second precision, a third precision, or a fourth precision.

2. The mixed-precision quantization method according to claim 1, wherein the first precision is higher than the second precision and the third precision, and the third precision is higher than the second precision.

3. The mixed-precision quantization method according to claim 2, wherein the first precision is higher than the fourth precision, and the fourth precision is higher than the third precision.

4. The mixed-precision quantization method according to claim 2, wherein the first precision is 32-bit floating point or 64-bit floating point.

5. The mixed-precision quantization method according to claim 2, wherein the second precision is 4-bit integer.

6. The mixed-precision quantization method according to claim 2, wherein the third precision is 8-bit integer.

7. The mixed-precision quantization method according to claim 2, wherein the fourth precision is 16-bit brain floating point.

8. The mixed-precision quantization method according to claim 1, wherein the objective function is signal-to-quantization-noise ratio, cross entropy, cosine similarity, or KL divergence (Kullback-Leibler divergence).

9. The mixed-precision quantization method according to claim 1, wherein when a plurality of final outputs and a plurality of original final outputs are obtained, the step of obtaining the value of the objective function according to the final output and the original final output comprises:
obtaining the value of the objective function according to the plurality of final outputs and the plurality of original final outputs.

10. The mixed-precision quantization method according to claim 1, wherein the step of obtaining the value of the objective function according to the final output and the original final output comprises:
obtaining the value of the objective function according to part of the final output and part of the original final output.
